(19) United States
(12) Patent Application Publication
(10) Pub. No.: US 2004/0108213 A1
(43) Pub. Date: Jun. 10, 2004

(54) Plating bath composition control

(76) Inventors: Robert T. Talasek, Morgan Hill, CA (US); Marc Van den Berg, Saratoga, CA (US); William F. Ryann, Brookfield, CT (US)

Correspondence Address: ATMI, INC., 7 COMMERCE DRIVE, DANBURY, CT, 06810, US

(21) Appl. No.: 10/314,776

(22) Filed: Dec. 9, 2002

(51) Int. Cl. C25D 5/00; B05C 11/00

(52) U.S. Cl. 205/81; 205/101; 118/664

(57) ABSTRACT

A method of plating bath composition control. The method may include analysis of a plating bath to determine byproduct concentrations and changing the composition of the plating bath as a result thereof. Additionally, plating bath solution may be circulated between reservoirs before, during, or after the analysis and the changing of the composition. Methods may be carried out with use of a system having separate reservoirs, an analyzer, and a dosing controller for the changing of the composition.

### BACKGROUND

Embodiments described relate to plating bath constituents. In particular, embodiments relate to monitoring and maintaining a plating bath composition within desired parameters for deposition of a metal on a substrate.

### BACKGROUND OF THE RELATED ART

Processes which utilize plating baths having dissolved ions of a metal are becoming increasingly popular for applications requiring plating of the metal on a substrate. For example, in the semiconductor industry copper, or another metal is often deposited from such a plating bath to provide material on a substrate for the formation of semiconductor features. Such device features may include parallel metal lines, formed in trenches of a semiconductor substrate. Additionally, due to conductivity and other factors, copper is often the metal chosen to form semiconductor features. However, other metals may be chosen.

In order to ensure proper plating of the metal, additives are often included within the plating bath. For example, in an electrochemical or electroless deposition process, organic suppressors, accelerators, and levelers may be included in the plating bath. The particular amount and combination of additives and ions of the metal selected is a matter of design choice to help ensure that the metal is uniformly plated and lacking in significant defects. For example, where metal lines are to be formed in trenches of the substrate, as noted above, it is important that the metal be plated in such a manner as to avoid the formation of voids in the metal lines. Void formation in a metal line may render the feature useless along with any integrated circuit incorporating such a circuit feature.

As noted above, the right amount and combination of additives, metal ions, and other constituents of a plating bath may help to ensure uniform plating and the subsequent formation of defect free circuit features. Therefore, the concentration of each of these constituents may be monitored over the course of the life of the plating bath in order to ensure continuous, uniform and defect free plating. For example, where a particular plating process calls for a particular amount of a suppressor additive, it may be beneficial to monitor the concentration of the suppressor additive. Therefore, when a drop in the concentration of the additive suppressor is detected, additional suppressor additive may be added to the plating bath.

Unfortunately, over the life of a plating bath, additional constituents are formed. These additional constituents may be byproducts of the additives, not originally present at the beginning of the life of the plating bath. That is, a byproduct may form as an organic or inorganic additive is spent and breaks down into the byproduct. Byproducts, in and of themselves, may affect plating. That is, in addition to representing a depletion of additive, the actual byproduct of an additive may have a direct impact on the plating process. In an attempt to control byproduct levels in a plating bath, the plating bath may be blindly dumped on a periodic basis. The subsequent replacement of the dumped plating bath with a fresh plating bath may be quite expensive. This expense is incurred every time a fresh plating bath is to be provided in this manner.

### BRIEF DESCRIPTION OF THE DRAWINGS

FIG. 1 is a sectional overview of a plating bath control system (PBCS).

FIG. 2 is a sectional view of an analyzer of the PBCS taken from section lines 2-2 of FIG. 1.

FIG. 3 is a sectional view of a dosing controller of the PBCS of FIG. 1

FIG. 4 is a side sectional view of a plating unit of the PBCS of FIG. 1.

FIG. 5 is a side cross sectional view of a substrate having a metal line formed in the plating unit of FIG. 4.

FIG. 6. is a flow-chart summarizing embodiments of plating with the PBCS of FIG. 1.

### DETAILED DESCRIPTION

While embodiments are described with reference to certain plating bath compositions and methods additional compositions and methods may be employed. For example, embodiments may include plating bath solution with constituents and by products described further herein as well as others. Additionally, methods of monitoring, maintaining, and plating with the plating bath solution may be tailored as particularly described herein or otherwise. Namely, embodiments described may be particularly useful for addressing plating bath composition changes, including with respect to the formatting of byproducts.

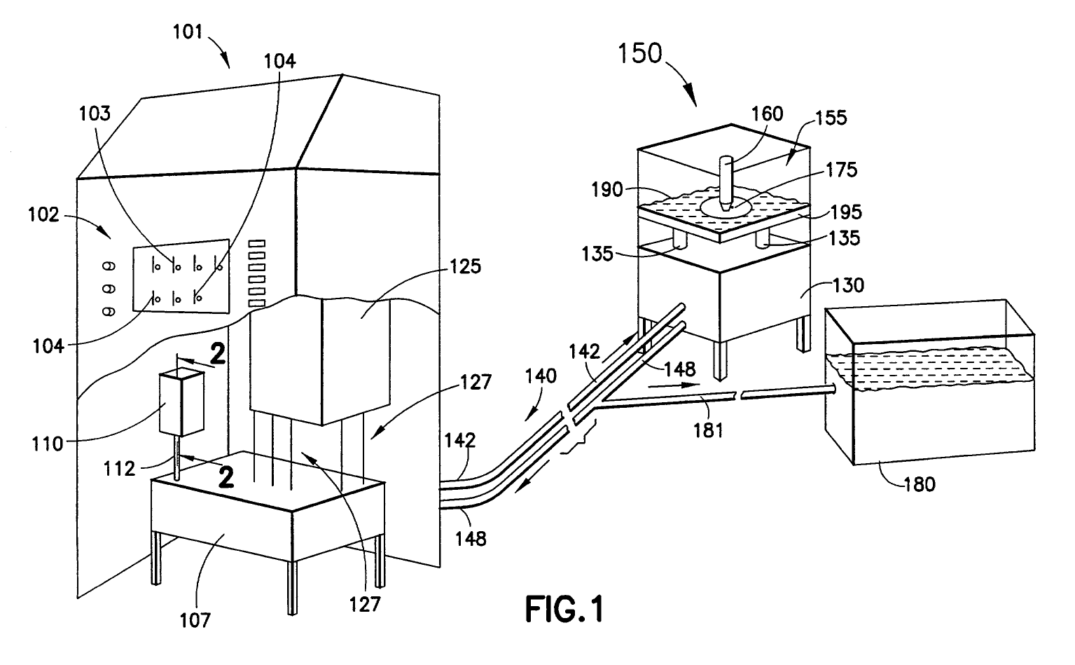

Referring now to FIG. 1, a plating bath control system (PBCS) 100 is shown. The PBCS 100 includes a plating unit 150 having a reaction chamber 155 where plating takes place. An arm 160 is provided from which the substrate 175 is suspended for plating. In one embodiment, electroplating of metal ions is directed from a plating bath solution 190 in contact with the lower surface of the substrate 175. As described further herein, the plating may be directed by a maintenance unit 101 of the PBCS 100.

In the embodiment shown, the plating unit 150 is coupled to the maintenance unit 101 by a circulation mechanism 140. The circulation mechanism 140 includes an output line 142 from a storage reservoir 107 of the maintenance unit 101 to the plating unit 150. The circulation mechanism 140 also includes a return line 148 from the plating unit 150 to the storage reservoir 107. Each line 142, 148 may include a conventional rotary or other pump incorporated therein for transfer of plating bath solution 190 between the storage reservoir 107 and the plating unit 150. The PBCS 100 of FIG. 1 includes a single plating unit 150 for metalization of a single wafer 175. However, several plating units 150 may be coupled to the maintenance unit 101 as indicated, each accommodating additional wafers. In one embodiment four plating units 150 are coupled to the maintenance unit 101 and storage reservoir 107.

In the embodiment shown in FIG. 1, circulating plating bath solution 190 is actually delivered from the output line 142 to a buffer reservoir 130 of the plating unit 150. The buffer reservoir 130 is coupled to a plating reservoir 195 by buffer lines 135. The plating reservoir 195 contains plating bath solution 190 employed during deposition. Plating bath solution 190 is circulated between the buffer reservoir 130 and the plating reservoir 195 through the buffer lines 135 similar to the manner described with reference to the circulation mechanism 140 noted above. The plating reservoir 195 is readily subject to depletion of plating bath solution due to it's lower volume capacity as described below. The presence of the buffer reservoir 130, however, sized between the storage 107 and plating 195 reservoirs, helps ensure that the plating reservoir 195 remains substantially filled.

The storage reservoir 107 may hold between about 4 gallons and about 50 gallons of plating bath solution 190, preferably between about 5 gallons and 15 gallons. By contrast, the buffer reservoir 130 may hold between about 0.5 gallons and about 5 gallons, while the plating reservoir 195 may contain between about 100 ml and about 700 ml. Due to the smaller volumes of the buffer 130 and plating 195 reservoirs, constituent changes at the storage reservoir 107 are more readily realized at the reservoirs 130, 195 of the plating unit 150.

Plating bath solution 190 within the output line 142 may be driven away from the storage reservoir 107 and to the plating unit 150. Simultaneously plating bath solution 190 from the plating unit 150 may be driven from the plating unit 150 to the storage reservoir 107 through the return line 148. As described further herein, such a circulation of the plating bath solution 190 may be maintained throughout a plating procedure in order to ensure a substantially consistent composition of the plating bath solution 190 between the storage reservoir 107 and the plating unit 150.

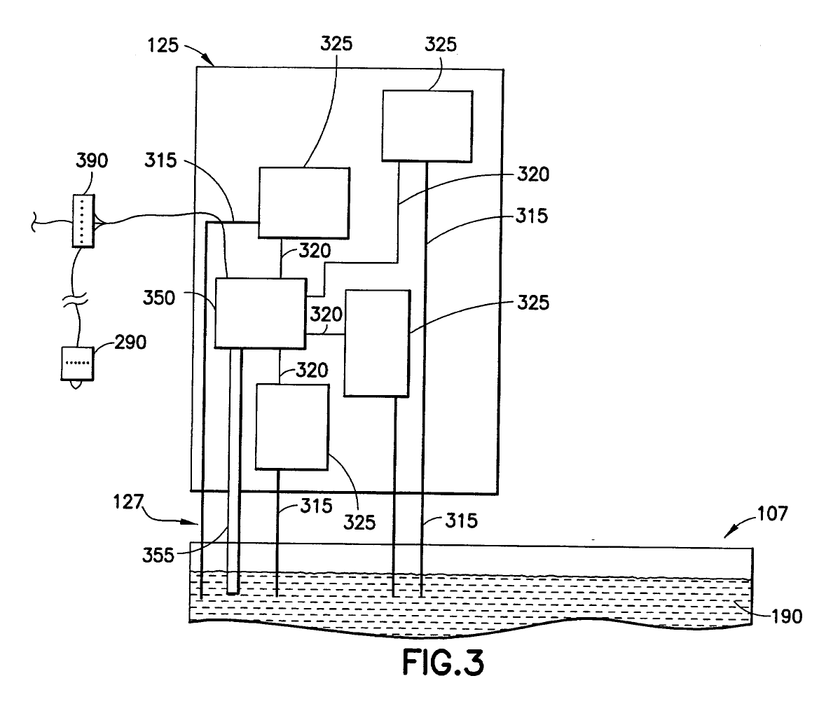

Continuing with reference to FIG. 1, the maintenance unit 101 includes a dosing controller 125. As described further herein, the dosing controller 125 may deliver a variety of constituents to plating bath solution 190 within the storage reservoir 107. A line series 127 couples the dosing controller 125 to the storage reservoir 107 for delivery of constituents to the plating bath solution 190. Delivery of a particular constituent by the dosing controller 125 may be directed by input from a central processor 390 (see FIG. 3), as also described further herein.

The maintenance unit also includes an analyzer 110. An analyzer line 112 is provided which couples the analyzer 110 and the storage reservoir 107 for sampling of plating bath solution 190. That is, as described further herein, samples of plating bath solution 190 may be periodically drawn from the storage reservoir 107 for analysis by the analyzer 110. The frequency of such sampling and analysis may be directed by the central processor 390 (see FIG. 3) noted above. The analyzer 110 employs methods which allow the detection of original constituents of the plating bath solution 190. The analyzer 110 may also detect breakdown or byproducts of organic additives of the plating bath solution 190 which increase as the organic additives are consumed during plating within the plating unit 150.

Continuing with reference to FIG. 1, an interface 102 is shown. In the embodiment shown, the interface includes a display screen and with various side controls and indicators as shown. In one embodiment the display screen is a touch screen, which allows a user to direct a plating procedure to be run by the PBCS 100. The user may use the interface 102 to initiate or terminate a plating procedure. Parameters for analysis and maintenance of the plating bath solution 190 by the PBCS 100 may also be set by the user at the interface 102.

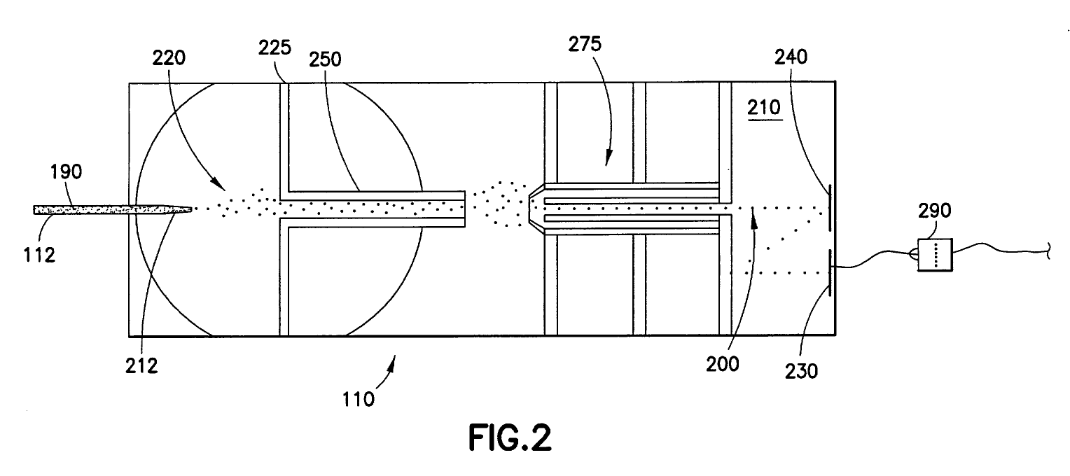

In the embodiment shown in FIG. 2, the analyzer 110 includes an analyzer microprocessor 290. The analyzer microprocessor 290 may translate and deliver analysis data to the central processor 390 to direct a display at the interface 102. This display is based on analysis of the plating bath solution 190 from the storage reservoir 107. In one embodiment the interface 102 displays a row indicating detected levels of original constituents of the plating bath solution 190, referred to here as a constituent row display 103. Thus, in an embodiment where constituents of the plating bath solution 190 include copper ions, and organic suppressor, leveler, and accelerator additives, levels of such constituents may be displayed at the interface 102. As these constituent levels drop during consumption at the plating unit 150, the detection of this drop in levels may be displayed at the constituent row display 103 of the interface 102.

As noted above, the analyzer 110 may also detect breakdown or byproducts of organic additives of the plating bath solution 190. As plating occurs and organic additives are consumed and converted into these byproducts, increased byproduct levels are detected by the analyzer 110. Thus, increased byproduct levels may be displayed at the interface 102 in the manner described above. That is, the interface 102 may include a byproduct row display 104 indicative of byproduct levels and able to readily show any increase in such levels to the user.

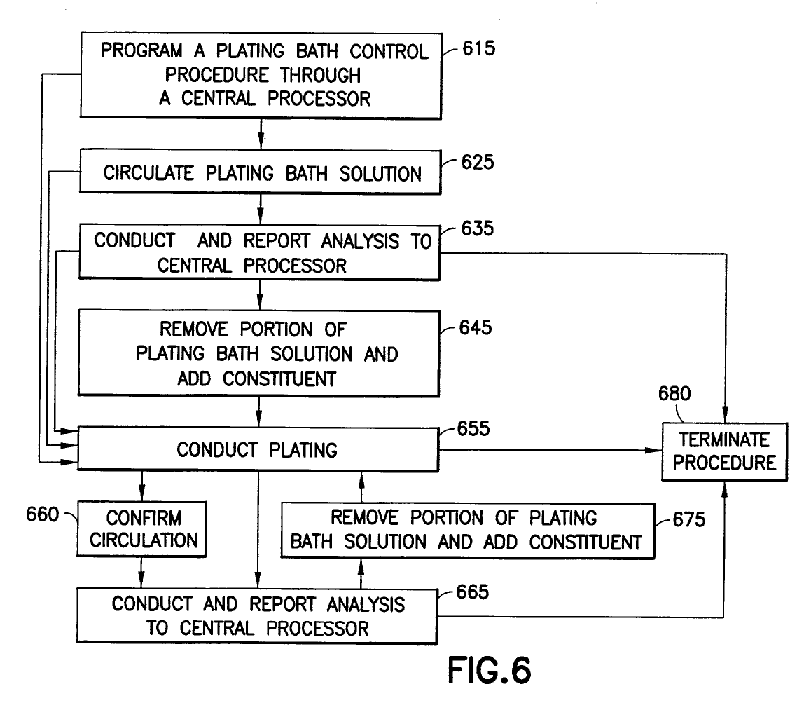

Coordination of the above described features of the maintenance unit 101 into the same plating bath control procedure is achieved through the central processor 390 (see FIG. 3) as indicated at 615 of FIG. 6. FIG. 6 is a flow chart summarizing embodiments of plating with the PBCS 100 (as shown in FIG. 1). FIG. 6 is referenced throughout the remainder of the description as an aid in describing such embodiments.

In one embodiment parameters of a plating bath control procedure are established by a user at the interface 102. In response thereto, the circulation mechanism 140 may begin circulation of plating bath solution 190 between the plating unit 150 and the storage reservoir 107 as indicated at 625 of FIG. 6. The rate of this circulation is based on the program established by the user.

Continuing with reference to FIGS. 1 and 6, to ensure proper composition of the plating bath solution 190, initial sampling and analysis may be performed by the analyzer 110 prior to plating at the plating unit 150. As shown at 635 of FIG. 6 this analysis is reported to the central processor 390 (see FIG. 3) to determine subsequent action by the PBCS 100, if any. Alternatively, the user may program the maintenance unit 101 to proceed to conduct plating without prior analysis of the plating bath solution 190 (see 655 of FIG. 6). Similarly, the user may direct the maintenance unit 101 to proceed without activation of the circulation mechanism 140. Particular parameters of the plating bath control procedure, such as these and others described below, are a matter of design choice, established by the user based on factors such as the particular constituents of the plating bath solution 190 or the amount of plating to take place.

Referring to FIG. 2, a sectional view of the analyzer 110 is shown taken from section line 2-2 of FIG. 1. With additional reference to FIG. 1, the analyzer line 112 draws in a sample of plating bath solution 190 by conventional means from the storage reservoir 107 as shown in FIG. 1. The analyzer line 112 terminates at a needle 212 within the analyzer 110 where constituents of the plating bath solution 190 are analyzed as described further here.

Initially, the sample of the plating bath solution 190, generally less than about 1 ml., is drawn to the tip of the needle 212 where constituent ions 220 evaporate and are drawn toward an electric field 225. In one embodiment solvent molecules are driven away from the electric field 225 by heated nitrogen or other conventional means. A capillary tube 250 is in communication with the electric field 225 and directs constituent ions 220 through a region of reduced pressure. The constituent ions 220 advance toward an ion trap configured to retain constituent ions 220 of a predetermined size such that an ion stream 200 is formed. The particular ions retained within the ion stream 200 are determined by the user depending upon the particular parameters selected for the plating bath control procedure as well as the constituents of the plating bath solution 190.

The ion stream 200 is directed toward a pulsing mechanism 240, which applies pulses of energy sufficient to physically separate individual ions of the ion stream 200. The individual ions travel along a path and are reflected toward a detector 230. The detector 230 may include a diode or other conventional detection mechanism. Lighter ions travel faster along the path reaching the detector 230 in advance of heavier ions to follow. As particular ions are detected by the detector 230, the data is wired to the analyzer microprocessor 290 for interpretation. That is, information regarding constituents and constituent levels is now available. With additional reference to FIG. 3, this information may be directed back to the central processor 390. The information may then be utilized in accordance with the parameters of the selected plating bath control procedure as described further below.

As described above, the byproducts may be directly analyzed and measured by a mass spectrometer technique. However, analysis may be performed directly or indirectly by optical, electrochemical, or other conventional techniques. For example, in an alternate embodiment primary additive and metal ion constituents are optically evaluated, while byproducts are determined therefrom.

With reference to FIGS. 3 and 6, the analytical information regarding the plating bath solution 190 may be put to use. Again, the particular use of this information will depend on the parameters of the selected plating bath control procedure selected by the user and programmed into the central processor 390 as indicated at 615. For example, in an embodiment where the plating bath solution 190 is to include copper ions and organic additives disbursed in an acid solution, the plating bath control procedure may call for the maintenance of a particular level of copper ions in the plating bath solution. When analysis, such as that described above, provides information that the plating bath solution 190 is below the particular level, the central processor 390 may respond to the information to cause the dosing controller 125 to deliver additional copper ions as indicated at 645 and at 655 of FIG. 6, described further below. Once plating is initiated at the plating unit 150 (see FIG. 1) and as indicated at 655 of FIG. 6, an automated response to an undesirably low level of copper ions as indicated at 675 allows plating to continue in an uninterrupted manner until complete (i.e. or terminated as indicated at 685). Thus, expenses associated with termination of plating and treatment or replacement of the plating bath solution 190 are avoided.

As indicated at 645 and 675, constituent may be added to change the composition of the plating bath solution 190. This change in composition may be accompanied by a change in the total volume of the plating bath solution 190. Therefore, in one embodiment, a portion of the plating bath solution 190 is withdrawn and directed toward a bleed reservoir 180 as shown in FIG. 1, prior to addition of constituent. The bleed reservoir may accommodate up to about 50 gallons of plating bath solution 190. The portion of the plating bath solution 190 withdrawn may be substantially equivalent to the volume of constituent to be added. In this manner, the total volume of plating bath solution 190 remains relatively unchanged and consistent during use of the PBCS 100.

In one embodiment the withdrawn portion of plating bath solution 190 is taken by a bleed line 181 from a location between the output line 142 and the storage reservoir 107, such as at the return line 148 as shown. That is, traveling along a path of the circulating plating bath solution 190, withdrawal from areas further form the storage reservoir 107, where constituents are added, and closer to the reaction chamber 155, where constituents are consumed, may aid in removal of more byproducts and fewer metal ions or desired additives. Thus, the overall life of the plating bath solution 190 may be further extended.

In addition to maintaining metal ion levels for plating, the plating bath control system 100 shown in FIG. 1 may account for many other constituents of a plating bath solution 190. This includes byproducts of additives of the plating bath solution 190 which form after plating is initiated as described below.

A plating bath solution 190 includes an ion source such as the above referenced copper ions, generally provided by way of a copper salt dissolved in an acid solution. For example, the plating bath solution 190 may include copper sulfate dissolved in a hydrochloric acid and/or sulfuric acid solution. Additionally, organic additives may be dissolved in the plating bath solution 190. The additives may be provided to help ensure level and uniform plating of the metal at the substrate 175 within the plating unit 150 as shown in FIG. 1. For example, additives may help to control the rate of metal deposition during plating so as to prevent the formation of voids or other defects in the forming metal layer. Like other constituents of the plating bath solution 190, additive levels may be determined with the aid of the analyzer 110 in the same manner as described above.

Additives may include suppressors, often referred to as wetting agents or carriers. Suppressors are surfactants which tend to accumulate closer to the surface of a substrate and slow down metal deposition during plating. For example, with added reference to FIG. 5, surfactant may accumulate at lower or middle regions 510, 520 of a trench 501 to help ensure that the lower portion of a metal line 500 forms defect-free during plating. Suppressors may include poly-ethers and long chain polymers such as polyethylene glycol (PEG), polypropylene glycol (PPG). Polyalkylene glycol and co-polymers of poly-oxyethylene and polyoxypropylene may also be used.

Additives may also include accelerators, often referred to as brightener or anti-suppressors. Accelerators help to ensure that plating of the metal proceeds and at a less inhibited rate once, for example, at the upper region 530 as shown in FIG. 5. Accelerators include negatively charged molecules such as those containing sulfur with sulfonic acid groups or disulfides such as sulfo-propyl-di-sulfide (SPS). This may include bis-(sodiumsulfopropyl)-disulfide, 3-[(ethoxy-thioxomethyl)thio]- (OPX), or 3([(dimethylamino)-thioxomethyl]-thio)- (DPS).

Additives may also include levelers. Levelers generally include high molecular weight polyamines, polyimines and polyamides, which help to prevent the formation of bumps or other surface irregularities, which tend to form at the top of the metal line 500.

In addition to the additives themselves such as these noted above, it may be desirable to track levels of additive byproducts. For example, in an embodiment where the accelerator SPS is employed, the byproduct mercapto-propane sulfonic acid (MPSA) will form. That is, as plating proceeds, SPS is consumed and converted to MPSA. Determining the level of MPSA will correlate to a drop in the level of SPS. Additionally, the build up of MPSA may affect the plating process, perhaps requiring the addition of SPS. Therefore, in one embodiment, the plating bath control procedure includes monitoring of the level of MPSA byproduct in the plating bath solution 190.

Continuing with reference to FIG. 3, information relating to the constituents of the plating bath solution 190 is obtained by the central processor 390 from the analyzer microprocessor 290 (see FIG. 2). The central processor 390 will then direct the plating bath control system 100 depending upon set parameters of the plating bath control procedure established by the user (see FIG. 1). For example, the central processor 390 may direct termination of the plating bath control procedure to prevent plating as indicated at 685 of FIG. 6. This may occur where additive or metal ion levels are determined to be too low, or where a byproduct level is determined to be too high. Alternatively, the central processor 390 may direct the dosing controller 125 to deliver more additive or metal ion source to the plating bath solution 190 in the manner shown at 645 of FIG. 6 and described below in advance of plating.

The dosing controller 125 shown in FIG. 3 includes constituent chambers 325 where isolated constituent sources of the plating bath solution are stored. The individual constituents may be dissolved in an acidic solution and maintained within the constituent chambers 325 in a more concentrated form than found in the plating bath solution 190. In one embodiment, each of a copper ion source, a suppressor, an accelerator, and a leveler are stored in individual constituent chambers 325. The dosing controller 125 is coupled to the storage reservoir 107 by the line series 127 described above. The line series 127 includes a plating bath solution line 315 from each constituent chamber 325 whereby a regulated amount of constituent may be added directly to the plating bath solution 190. Such addition of a regulated amount of constituent in this manner is directed by the central processor 390 based upon particular plating bath control parameters as programmed by the user.

The dosing controller 125 shown also includes a constituent mixer 250. Each of the constituent chambers 325 is coupled to the constituent mixer 350 with a mixer line 320. Depending on particular plating bath control procedure parameters and detected constituent levels by the analyzer 110 (see FIGS. 1 and 2), the central processor 390 may direct individual constituents from separate constituent chambers 325 through the mixer lines 320 and into the mixer 350.

Once in the mixer 350 individual constituents combine to form a dosing solution for addition to the plating bath solution 190 at the storage reservoir 107. In one embodiment the mixer 350 includes an external mixing mechanism avoiding direct contact with the dosing solution. In this manner, the dosing solution may be mixed and the external mixing mechanism replaced when necessary without contamination concerns. The external mixing mechanism may include a series of piezoelectric actuators or a conventional agitator coupled to an exterior portion of the mixer 350 to encourage uniform disbursement of constituents throughout the dosing solution. Alternatively, the individual constituents may be allowed to come together passively in forming the dosing solution within the mixer 350.

Once the dosing solution is present within the mixer 350, it may be delivered to the plating bath solution 190 through a delivery line 355 of the line series 127 as directed by the central processor 390. The dosing solution may be partially or entirely delivered in this manner.

As shown in FIG. 3, the central processor 390 is wired to the mixer 350. The central processor 390 is also wired to each of the individual constituent chambers 325 to control addition of constituent to the plating bath solution 190 as described above. As described herein, the determination of the exact manner and amount of each particular constituent added is established by the parameters of the plating bath control procedure set by the user generally in light of the constituent analysis allowed by the analyzer 110 as described above (see FIGS. 1 and 2). Even in the case of elevated byproduct levels, such levels may be directly detected and the composition of the plating bath solution 190 changed as a result.

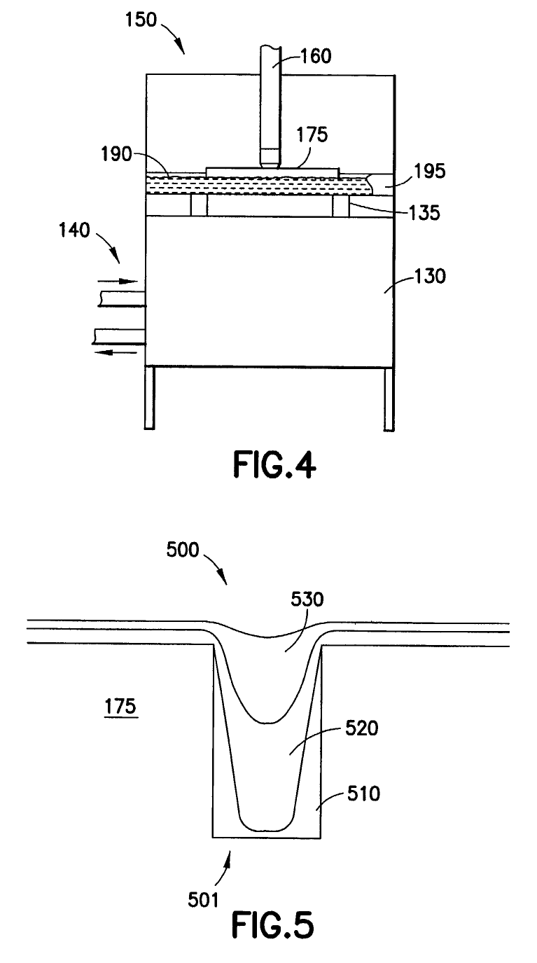

Referring now to FIGS. 4 and 5, the plating unit 150 is shown having a substrate 175 suspended by an arm 160 in a conventional manner for plating. Plating bath solution 190 may be continuously circulated in and out of the plating unit 150 by the circulation mechanism 140 as described above. This may be done in a manner, which maintains a constant level of plating bath solution 190 in the plating unit 150. Thus, any constituent additions made at the storage reservoir 107 (see FIGS. 1 and 3) will have effect at the plating unit 150.

In one embodiment, plating proceeds by conventional electroplating. That is, the plating is initiated by providing an electrical charge to energize an anode in contact with the plating bath solution 190 as directed by the central processor 390 (see FIG. 3). As a result, the substrate acts as a cathode attracting metal ions of the plating bath solution 190 for deposition at the surface thereof. As shown in FIG. 5 and described above, the plating bath control system 100 maintains the plating bath solution 190 within desired parameters to allow continuous controlled plating (see FIG. 1). As a result, plating may proceed in a defect free manner, even where difficult circuit features are to be formed in the substrate 175, such as the metal line 500 shown in FIG. 5.

Referring now to FIG. 6 in particular, embodiments of plating with the PBCS 100 of FIG. 1 as described above, are summarized here. As shown at 615, parameters of a plating bath control procedure are initially programmed through a central processor. As described above, this may be done by the user through an interface 102, such as that of FIG. 1. This may be followed immediately by conventional plating, which is eventually terminated according to the parameters of the plating bath control procedure (as indicated at 655 and 685). Alternatively, as indicated below, the PBCS 100 may be employed to provide analysis of a plating bath solution before or throughout plating.

As indicated at 625, 660 and described further above, circulation may be provided to the plating bath solution to ensure proper analysis. In one embodiment, analysis is reported to the central processor as indicated at 655 during plating. Depending upon the evaluation of the analysis by the central processor, constituent may be added 675, plating continued 655, or the procedure terminated 685. In another embodiment, a similar analysis may be performed and reported to the central processor prior to plating (see 635). Similar to that described above, evaluation of this analysis by the central processor may be used to determine whether constituent is added 645, plating initiated 655, or the entire procedure terminated 685.

Embodiments described above may allow direct, real-time detection and analysis of byproducts and other plating bath constituents. This is done in a manner, which allows a direct change in the composition of the plating bath solution. Embodiments described avoid the need and expense associated with blind dumping of the plating bath as a means to prevent byproduct buildup. Additional constituent may even be added to the plating bath solution in an automated manner. Such maintenance of the plating bath solution allows the user to directly and efficiently counter many effects incurred by the buildup of byproducts.

We claim:

1. A method comprising:
analyzing a portion of a plating bath to determine a concentration of a byproduct of an additive of the plating bath; and
changing the composition of the plating bath based upon said analyzing.

2. The method of claim 1 further comprising programming a plating bath control procedure through a central processor prior to said analyzing.

3. The method of claim 1 further comprising circulating the plating bath through a plating bath control system prior to said analyzing.

4. The method of claim 1 wherein the byproduct is mercapto-propane sulfonic acid.

5. The method of claim 1 wherein said changing comprises:
removing a portion of the plating bath; and
adding a constituent to the plating bath.

6. The method of claim 5 wherein the constituent is one of a metal ion, an accelerator, a suppressor, and a leveler.

7. The method of claim 5 further comprising:
plating a metal from the plating bath onto a substrate; and
repeating said analyzing and said changing.

8. The method of claim 7 further comprising continuing said plating after said repeating.

9. The method of claim 8 further comprising confirming circulation of the plating bath through a plating bath control system prior to said continuing.

10. A method comprising:
circulating a plating bath solution between a first reservoir and a second reservoir;
analyzing a portion of the plating bath solution at one of the first reservoir and the second reservoir; and
changing the composition of the plating bath solution based upon said analyzing.

11. The method of claim 10 further comprising programming a plating bath control procedure through a central processor prior to said analyzing.

12. The method of claim 10 wherein said analyzing comprises determining a concentration of a byproduct of an additive of the plating bath solution.

13. The method of claim 10 wherein said changing comprises:
removing a portion of the plating bath solution; and
adding a constituent to the plating bath at the one of the first reservoir and the second reservoir.

14. The method of claim 13 wherein the constituent is one of a metal ion, an accelerator, a suppressor, and a leveler.

15. The method of claim 13 further comprising:
plating a metal form the plating bath solution onto a substrate; and
repeating said analyzing and said changing.

16. The method of claim 15 further comprising continuing said plating after said repeating.

17. The method of claim 16 further comprising confirming said circulating prior to said continuing.

18. A system comprising:
a storage reservoir coupled to a plating reservoir, a plating bath solution to be circulated therebetween;
an analyzer for analyzing a portion of the plating bath solution; and
a dosing controller coupled to one of said storage reservoir and the plating reservoir and for changing a composition of the plating bath solution based upon the analyzing.

19. The system of claim 18 wherein said plating reservoir is between about 100 ml and about 700 ml in volume.

20. The system of claim 18 wherein said storage reservoir is between about 4 gallons and about 50 gallons in volume.

21. The system of claim 18 wherein the analyzer operates by one of an optical, an electrochemical, and a mass spectroscopy technique.

22. The system of claim 18 further comprising an interface for one of displaying and directing a plating bath control procedure.

23. The system of claim 18 wherein said dosing controller is coupled to said storage reservoir for the changing.

24. The system of claim 23 further comprising a bleed reservoir disposed between said storage reservoir and said plating reservoir.

25. The system of claim 24 further comprising:
an output line to direct the plating bath solution form said storage reservoir to said plating reservoir; and
a return line to deliver the plating bath solution from said plating reservoir to one of said storage reservoir and said bleed reservoir.

26. The system of claim 24 wherein said bleed reservoir is up to about 50 gallons in size.

27. The system of claim 18 wherein said dosing controller comprises:
at least one constituent chamber for storing at least one constituent to be added to the plating bath solution; and
a constituent mixer for mixing the at least one constituent prior to the changing.

28. The system of claim 27 wherein said at least one constituent chamber is configured to accommodate one of a metal ion source and an additive.

29. The system of claim 18 further comprising a buffer reservoir disposed between said storage reservoir and said plating reservoir, said buffer reservoir sized between a size of said storage reservoir and said plating reservoir.

30. The system of claim 29 wherein said buffer reservoir is sized between about 0.5 gallons and about 5 gallons.

31. An apparatus comprising:
a constituent chamber for delivering a plating bath constituent to a plating bath solution in a first reservoir; and
a constituent mixer coupled to said constituent chamber and for optionally mixing the plating bath constituent and another constituent prior to said delivering, the plating bath solution to be circulated between the first reservoir and a second reservoir.

32. The apparatus of claim 31 wherein the plating bath constituent and the another constituent include one of a metal ion source, an acid, a leveler, an accelerator, and a suppressor.

33. The apparatus of claim 31 wherein said constituent mixer includes an external mixing mechanism to avoid contact with the plating bath constituent.

34. The apparatus of claim 31 wherein said constituent chamber is directly coupled to the first reservoir.

35. The apparatus of claim 31 coupled to a central processor for directing the delivering, the directing based on one of a preset plating bath control procedure and analysis of a portion of the plating bath solution from the first reservoir.

36. A composition comprising an acid solution containing one of a metal ion and a plating bath additive, a portion of said composition, upon analyzing a portion of a plating bath solution, to be added to the plating bath solution circulating through a plating bath control system.

37. The composition of claim 36 wherein said acid solution includes one of hydrochloric acid and sulfuric acid.

38. The composition of claim 36 wherein the metal ion is copper.

39. The composition of claim 36 wherein the plating bath additive is one of a suppressor, an accelerator, and a leveler.

40. The composition of claim 39 wherein the suppressor is one of polyethylene glycol, polypropyleneglycol, and polyalkylene glycol.

41. The composition of claim 39 wherein the accelerator is one of bis-(sodiumsulfopropyl)-disulfide, 3-[(ethoxy-thioxomethyl)thio]-, and 3-([(dimethylamino)-thioxomethyl]-thio)-.

42. The composition of claim 39 wherein the leveler is one of a polyamine, a polyimine and a polyamide.
